(19) United States
(12) Patent Application Publication
(10) Pub. No.: US 2022/0371810 A1
(43) Pub. Date: Nov. 24, 2022

(54) Solar Powered Warming Container Apparatus

(71) Applicants: Oluwatosin Osowo, Irving, TX (US); Ayodele Osowo, Irving, TX (US)

(72) Inventors: Oluwatosin Osowo, Irving, TX (US); Ayodele Osowo, Irving, TX (US)

(21) Appl. No.: 17/323,338

(22) Filed: May 18, 2021

(51) Int. Cl. B65D 81/34; A47J 36/24

(52) U.S. Cl. CPC B65D 81/3476; A47J 36/2483; B65D 81/3818

(57) ABSTRACT

A solar powered warming container apparatus for keeping food warm for prolonged periods of time includes a container body having a container sidewall, a container bottom, and an open container top side. The container body stores warm food. A plurality of heating coils is coupled within the container body. A lid has a lid bottom side is selectively engageable with the container sidewall to seal the container top side. The lid is fully separable from the container body. A solar panel is coupled to a lid top side. A converter is coupled within the lid and is in operational communication with the solar panel and with the plurality of heating coils. A power switch is in operational communication with the plurality of heating coils to selectively turn on or off the heating coils when the converter is supplying power to the plurality of heating coils.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food container devices and more particularly pertains to a new food container device for keeping food warm for prolonged periods of time. The present device includes heating coils throughout a bottom side and a sidewall of the container. These heating coils are powered by solar panels on a removable lid.

### (2) Description of Related Art Including Information Disclosed Under 37 CFR 1.97 and 1.98

The prior art relates to food container devices. Known devices typically have power sources within the container that may be supplemented by a solar panel. When the solar panel is on the lid, the lid is not fully separable from the container.

### BRIEF SUMMARY OF THE INVENTION

An embodiment of the disclosure meets the needs presented above by generally comprising a container body having a container sidewall, a container bottom, and an open container top side. The container body is configured to store warm food. A plurality of heating coils is coupled within the container body. A lid is engaged with the container body. The lid has a lid top side and a lid bottom side. The lid bottom side is selectively engageable with the container sidewall to selectively seal the container top side. The lid is fully separable from the container body. A solar panel is coupled to the lid top side. A converter is coupled within the lid. The converter is in operational communication with the solar panel. The converter is in operational communication with the plurality of heating coils when the lid is engaged with the container body. A power switch is coupled to the container body. The power switch is in operational communication with the plurality of heating coils to selectively turn on or off the heating coils when the converter is supplying power to the plurality of heating coils.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a solar powered warming container apparatus according to an embodiment of the disclosure.

FIG. 2 is an isometric view of an embodiment of the disclosure.

FIG. 3 is a front elevation view of an embodiment of the disclosure.

FIG. 4 is a rear elevation view of an embodiment of the disclosure.

FIG. 5 is a bottom plan view of an embodiment of the disclosure.

FIG. 6 is a cross-sectional view of an embodiment of the disclosure along the line 6-6 of FIG. 1.

### DETAILED DESCRIPTION OF THE INVENTION

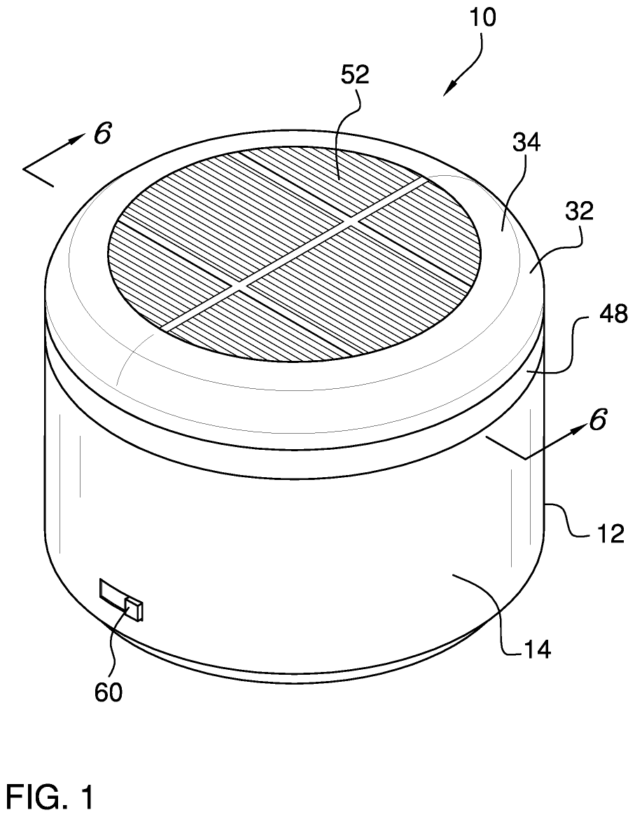

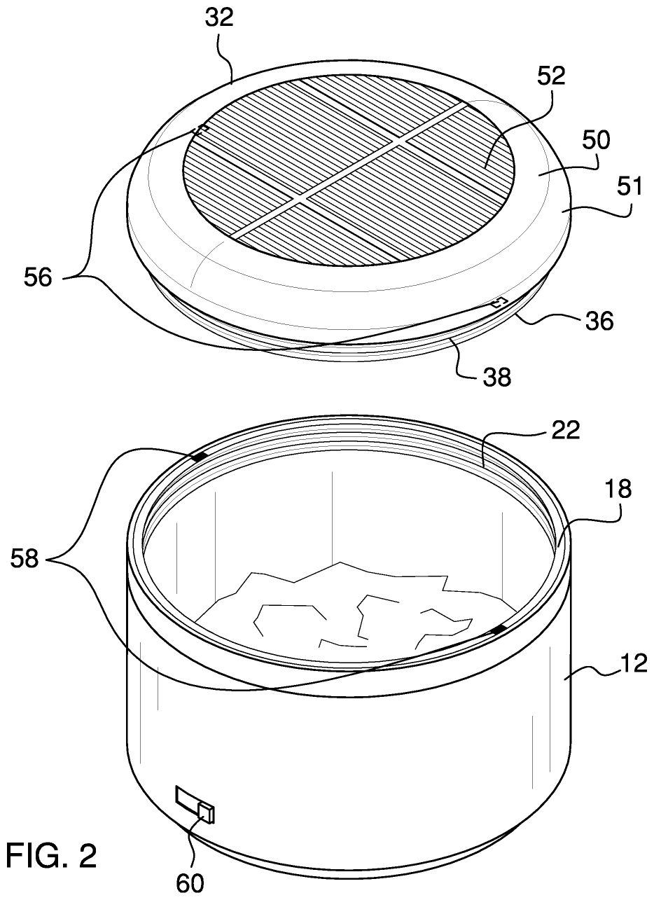

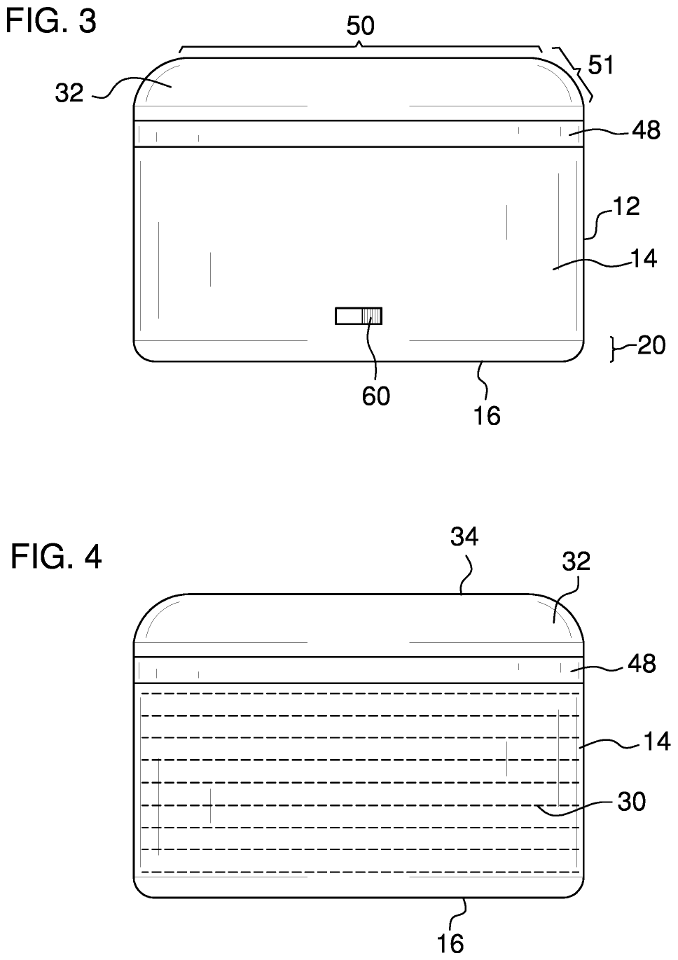

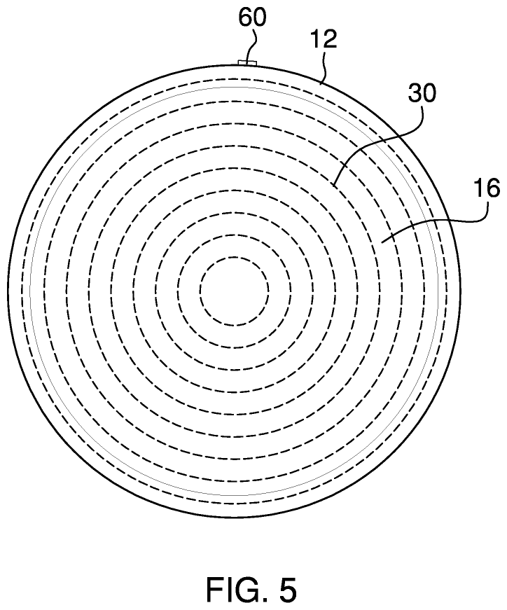

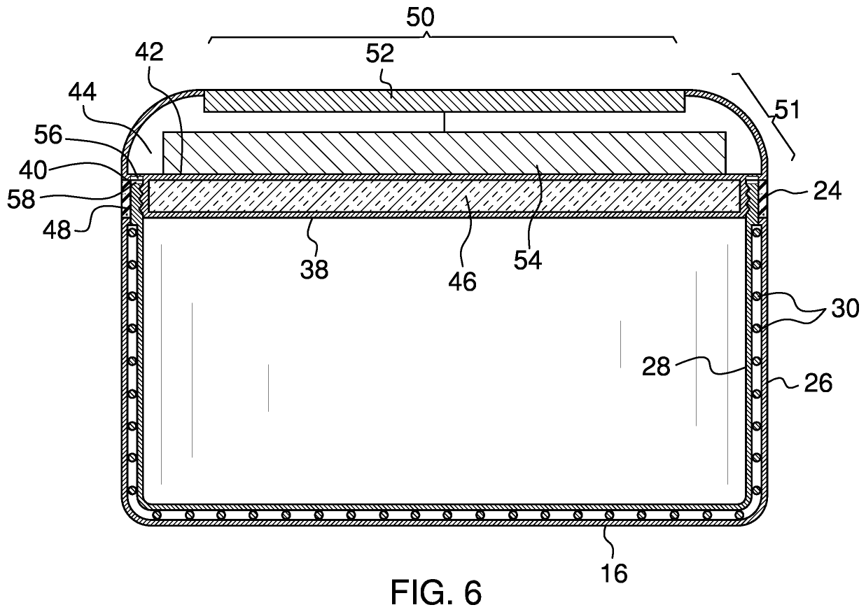

With reference now to the drawings, and in particular to FIGS. 1 through 6 thereof, a new food container device embodying the principles and concepts of an embodiment of the disclosure and generally designated by the reference numeral 10 will be described.

As best illustrated in FIGS. 1 through 6, the solar powered warming container apparatus 10 generally comprises a container body 12 having a container sidewall 14, a container bottom 16, and an open container top side 18. The container sidewall 14 may have a lower sidewall filleted portion 20 adjacent the container bottom 16. The container body 12 is configured to store warm food. The container sidewall 14 may have an inner threaded portion 22 adjacent the container top side 18 and an outer recessed portion 24 adjacent the container top side 18 and opposite the inner threaded portion 22. The container body 12 may include an outer shell 26 spaced apart from an inner shell 28. The outer shell 26 may be a durable rigid material such as, but not limited to, metal and the like while the inner shell 28 may be a better insulating material such as, but not limited to, glass and the like. A vacuum may be created between the outer shell 26 and the inner shell 28 to create additional insulation.

A plurality of heating coils 30 is coupled within the container body 12. The plurality of heating coils 30 is coupled between the outer shell 26 and the inner shell 28. The plurality of heating coils 30 coupled within the container bottom 16 may be concentric circles and the plurality of heating coils 30 coupled within the container sidewall 14 may be evenly spaced horizontal circles.

A lid 32 is engageable with the container body 12. The lid 32 has a lid top side 34 and a lid bottom side 36. The lid bottom side 36 may have a threaded central lid protrusion 38 and a perimeter lip 40. The lid 32 may have a lid divider wall 42 extending from the perimeter lip 40 and defining a lid interior 44 between the lid divider wall 42 and the lid top side 34. The threaded central lid protrusion 38 may be filled with an insulation 46 up to the lid divider wall 42.

The threaded central lid protrusion 38 is threadably engageable with the inner threaded portion 22 of the container sidewall. The perimeter lip 40 rests against the container top side 18 when the lid 32 is engaged with the container body 12. The lid 32 thus selectively seals the container top side 18. A sealing ring 48 may be coupled to the container body 12 the around the outer recessed portion 24 to create a watertight seal between the lid 32 and the container body 12. The lid top side 34 may have a planar top portion 50 and a filleted lid perimeter portion 51. The lid 32 is fully separable from the container body 12.

A solar panel 52 is coupled to the lid 12. The solar panel 52 is coupled to the lid top side 34. The solar panel 52 may be positioned flush with the planar top portion 50. A converter 54 is coupled within the lid 32 and is in operational communication with the solar panel 52. The converter 54 may be coupled to the lid divider wall 42 within the lid interior 44. The converter 54 is in operational communication with the plurality of heating coils 30 when the lid 32 is engaged with the container body 12. The converter 54 may have a plurality of top contact leads 56 extending through the perimeter lip 40 of the lid bottom side in operational communication with a plurality of bottom contact leads 58 extending through the container top side 18 and connected to the plurality of heating coils 30.

A power switch 60 is coupled to the container body 12. The power switch 60 is in operational communication with the plurality of heating coils 30 to selectively turn on or off the heating coils 30 when the converter 54 is supplying power to the plurality of heating coils 30. The power switch 60 may be coupled to the container sidewall 14.

In use, food is placed within the container body 12 and the lid 32 is engaged. The power switch 60 is then used to power the plurality of heating coils 30 with the solar panel 52, helping to keep the food warm for extended periods of time. The lid 32 is then removed to enjoy the hot food and the power switch 60 may be turned off while the container body 12 is empty.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar powered warming container apparatus comprising:
a container body having a container sidewall, a container bottom, and an open container top side, the container body being configured to store warm food;
a plurality of heating coils coupled within the container body;
a lid engaged with the container body, the lid having a lid top side and a lid bottom side, the lid bottom side being selectively engageable with the container sidewall to selectively seal the container top side, the lid being fully separable from the container body;
a solar panel coupled to the lid, the solar panel being coupled to the lid top side;
a converter coupled within the lid, the converter being in operational communication with the solar panel, the converter being in operational communication with the plurality of heating coils when the lid is engaged with the container body; and
a power switch coupled to the container body, the power switch being in operational communication with the plurality of heating coils to selectively turn on or off the heating coils when the converter is supplying power to the plurality of heating coils.

2. The solar powered warming container apparatus of claim 1 further comprising the lid bottom side having a threaded central lid protrusion and a perimeter lip, the threaded central lid protrusion being threadably engageable with an inner threaded portion of the container sidewall, the perimeter lip resting against the container top side when the lid is engaged with the container body.

3. The solar powered warming container apparatus of claim 2 further comprising the threaded central lid protrusion being filled with an insulation.

4. The solar powered warming container apparatus of claim 2 further comprising the container sidewall having an outer recessed portion adjacent the container top side and opposite the inner threaded portion; a sealing ring coupled to the container body, the sealing ring being coupled around the outer recessed portion and creating a watertight seal between the lid and the container body.

5. The solar powered warming container apparatus of claim 1 further comprising the container body including an outer shell spaced apart from an inner shell; the plurality of heating coils being coupled between the outer shell and the inner shell.

6. The solar powered warming container apparatus of claim 5 further comprising the inner shell being glass.

7. The solar powered warming container apparatus of claim 1 further comprising the lid top side having a planar top portion and a filleted lid perimeter portion.

8. The solar powered warming container apparatus of claim 1 further comprising the plurality of heating coils coupled within the container bottom being concentric circles.

9. The solar powered warming container apparatus of claim 8 further comprising the plurality of heating coils coupled within the container sidewall being evenly spaced horizontal circles.

10. A solar powered warming container apparatus comprising:
a container body having a container sidewall, a container bottom, and an open container top side, the container body being configured to store warm food, the container sidewall having an inner threaded portion adjacent the container top side and an outer recessed portion adjacent the container top side and opposite the inner threaded portion, the container body including an outer shell spaced apart from an inner shell;
a plurality of heating coils coupled within the container body, the plurality of heating coils being coupled between the outer shell and the inner shell, the plurality of heating coils coupled within the container bottom being concentric circles and the plurality of heating coils coupled within the container sidewall being evenly spaced horizontal circles;
a lid engaged with the container body, the lid having a lid top side and a lid bottom side, the lid bottom side having a threaded central lid protrusion and a perimeter lip, the threaded central lid protrusion being filled with an insulation, the threaded central lid protrusion being threadably engageable with the inner threaded portion of the container sidewall, the perimeter lip resting against the container top side when the lid is engaged with the container body, the lid selectively sealing the container top side, comprising the lid top side having a planar top portion and a filleted lid perimeter portion, the lid being fully separable from the container body;
a sealing ring coupled to the container body, the sealing ring being coupled around the outer recessed portion and creating a watertight seal between the lid and the container body;
a solar panel coupled to the lid, the solar panel being coupled to the lid top side;
a converter coupled within the lid, the converter being in operational communication with the solar panel, the converter being in operational communication with the plurality of heating coils when the lid is engaged with the container body; and
a power switch coupled to the container body, the power switch being in operational communication with the plurality of heating coils to selectively turn on or off the heating coils when the converter is supplying power to the plurality of heating coils.
